(19) United States
(12) Patent Application Publication
(10) Pub. No.: US 2015/0301741 A1
(43) Pub. Date: Oct. 22, 2015

(54) METHOD FOR SELECTING A CHARACTER ASSOCIATED WITH A KEY IN AN ELECTRONIC DEVICE

(71) Applicant: Samsung Electronics Co., Ltd., Suwon-si (KR)

(72) Inventors: Samudrala NAGARAJU, Bangalore (IN); Kumar ASHUTOSH, Uttar Pradesh (IN)

(21) Appl. No.: 14/689,272

(22) Filed: Apr. 17, 2015

(30) Foreign Application Priority Data
Apr. 18, 2014 (IN) 2016/CHE/2014

(51) Int. Cl. G06F 3/0488; G06F 17/27

(52) U.S. Cl. CPC G06F 3/04886; G06F 3/04883; G06F 17/276

(57) ABSTRACT

A method to select a character based on an extent level identified in a gesture performed on a key displayed in an electronic device is provided. Each key is associated with one or more characters. Further, the method includes displaying the pre-defined direction and the associated characters in a matrix keypad. When a user performs a gesture to input a character, then the method determines the character associated with the extent level of the performed gesture and displays the character.

### CROSS-REFERENCE TO RELATED APPLICATION(S)

This application claims the benefit under 35 U.S.C. §119(a) of an Indian patent application filed on Apr. 18, 2014 in the Indian Intellectual Property Office and assigned Serial number 2016/CHE/2014, the entire disclosure of which is hereby incorporated by reference.

### TECHNICAL FIELD

The present disclosure relates to character selection in an electronic device. More particularly, the present disclosure relates to selecting the character based on an extent level identified in a gesture.

### BACKGROUND

As touch-screen electronic devices continue to be reduced in size, device manufacturers are increasingly challenged with designing keypads that are small yet accurate and easy to use. Typically, the keypad is arranged in rows and/or columns with minimal spacing between adjacent keys.

In existing keypad design, characters such as alphabets and several other symbols are grouped under respective numerals, with one key being assigned to each of these groups. With these keypads, the user first presses a key assigned to the group to which the character, that the user wants to input, belongs. Next, if the user repeatedly presses that key, the characters in the group assigned to that specific key are switched in order and become selectable according to the number of key presses. Then, when the user stops pressing the key, the selectable character has become the desired character. By this, input of a desired character becomes possible.

In the case of this character input, multiple key press operations become necessary in order to select a character the user wants to input, and the user must conduct the vexing work of repeated key press operations.

In the existing method, the keypad configuration is static and it will not be changed based on the display portion of the device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method to select a character based on an extent level identified in a gesture performed on a key in an electronic device.

Another object aspect of the invention present disclosure is to provide a method to select a character when a gesture is performed in a pre-defined direction associated with a key.

Another object aspect of the invention present disclosure is to provide a method to remove a displayed character based on a gesture performed on a key in an electronic device.

In accordance with an aspect of the present disclosure, a method for determining a character in an electronic device is provided. The method includes displaying a plurality of keys and each key is associated with a plurality of characters. The method includes identifying an extent level of a gesture performed by the user on the key and each extent level corresponds to the character associated with the key. Further, the method includes determining the character corresponds to the identified extent level.

In accordance with another aspect of the present disclosure, an electronic device comprising an integrated circuit is provided. Further the integrated circuit comprises a processor, a memory having a computer program code. The memory and the computer program code with the processor cause the electronic device to display a plurality of keys, wherein each key is associated with a plurality of characters. Further the device is configured to identify an extent level of the gesture performed by the user on the key, wherein each extent level corresponds to the character associated with the key using an extent level identification module. The electronic device is further configured to determine the character corresponds to the identified extent level using a character determination module.

In accordance with another aspect of the present disclosure, a computer program product comprising computer executable program code recorded on a computer readable non-transitory storage medium is provided. The computer executable program code when executed causing the actions includes displaying a plurality of keys in a matrix in an electronic device, wherein each key is associated with a plurality of characters. The computer executable program code when executed causing further actions includes identifying an extent level of a gesture performed by the user on the key, wherein each extent level corresponds to a character associated with the key. The computer executable program code when executed causing further actions includes determining the character corresponds to the identified extent level.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device with various modules, according to various embodiments of the present disclosure;

FIG. 2 is a flow diagram illustrating a method of selecting a character in an electronic device, according to various embodiments of the present disclosure;

FIG. 3 is a pictorial representation showing different keypad configurations in an electronic device, according to various embodiments of the present disclosure;

FIG. 4 shows a 2*2 matrix keypad and key mapping associated with a pre-defined gesture direction, according to various embodiments of the present disclosure;

FIG. 5 is a flow diagram explaining a method of selecting a character based on an extent level associated with a pre-defined directional gesture, according to various embodiments of the present disclosure;

FIGS. 6A and 6B show keypad layouts in a 2*2 matrix, according to various embodiments of the present disclosure;

FIGS. 7A and 7B are pictorial representations of selecting a character associated with a key in a 4*3 keypad configuration, according to various embodiments of the present disclosure;

FIG. 8 shows a 6*2 matrix keypad and key mapping associated with a pre-defined gesture direction, according to various embodiments of the present disclosure;

FIGS. 9A and 9B show example illustrations of selecting a character, according to various embodiments of the present disclosure;

FIG. 10 is a flow diagram illustrating a method of removing one or more displayed characters based on a gesture, according to various embodiments of the present disclosure;

FIGS. 11A, 11B, and 11C show pictorial representations of removing one or more characters as described in FIG. 10, according to various embodiments of the present disclosure;

FIG. 12 is a flow diagram illustrating a method of displaying a matrix with a plurality of keys based on a visible region of an electronic device, according to various embodiments of the present disclosure;

FIGS. 13A and 13B show pictorial representations of displaying a matrix with a plurality of keys based on a visible region of an electronic device as described in FIG. 12, according to various embodiments of the present disclosure; and

FIG. 14 illustrates a computing environment implementing a method and system for selecting a character in an electronic device, according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to describing the various embodiments of the present disclosure in detail, it is useful to provide definitions for key terms and concepts used herein. Unless defined otherwise, all technical and scientific terms used herein have the same meaning as commonly understood by a person having ordinary skill in the art to which this disclosure belongs.

Character: Includes but not limited to alphabets, numerics, special characters, SPACE, language, symbols, upper case, lower case, dictionary mode or the like, associated with one or more keys in an electronic device.

Extent level: Defines the length of a gesture performed in selecting a character. It is independent of direction in which the gesture is performed.

The various embodiments herein achieve a method and system for selecting a character in an electronic device. The method includes displaying a plurality of keys in a matrix and each key is associated with a plurality of characters. The method includes receiving a gesture on the key. Further, the method includes identifying an extent level of the gesture. In an embodiment, each extent level corresponds to one or more characters associated with the one or more keys. Furthermore, the method includes selecting the character associated with the identified extent level and displays the character in the electronic device. In an embodiment, the method includes instantaneously displaying the character associated with the key before the gesture is completed.

In an embodiment, the gesture is a touch gesture performed on a touch screen electronic device.

In an embodiment, the gesture is a hover gesture performed on the touch screen electronic device.

In an embodiment, the method selects the character when the gesture is performed in a pre-defined direction associated with the key.

In an embodiment, the method displays the matrix based on a visible region of the electronic device.

In an embodiment, the method includes removing one or more displayed characters based on a gesture.

Unlike systems of the related art, the proposed method selects the character based on an extent level of the gesture performed on the key. In the conventional systems, whenever the user needs to select a character, the user needs to perform the gesture in a certain angle. To select multiple characters users would provide multi-touch input which results in a cumbersome experience to the user. In the proposed method, the user can perform the gesture in any angle/direction to select the one or more characters associated with the key.

Unlike systems of the related art in which the keypad configuration is fixed, the user cannot change the keypad configuration based on his/her convenience. In an embodiment of a disclosed method, the matrix including a plurality of keys can be dynamically displayed based on the visible region of the electronic device. The disclosed method can be used in any electronic device irrespective of the size and shape of the electronic device. The direction input is used to distinguish the initial key set and the user can perform the gesture in any direction. Further, the disclosed method uses a small area of the display screen to display the keypad allowing the user to select the character within the small screen.

Additionally, the proposed method uses existing keypad's key mapping for selecting the character. For example, the numeral 2 key is associated with a, b and c. Since, a user is familiar with this key mapping, there is no separate training required for the user to use the proposed method. Hence, the disclosed method provides enriched user experience in selecting one or more characters in one or more keys of the electronic device.

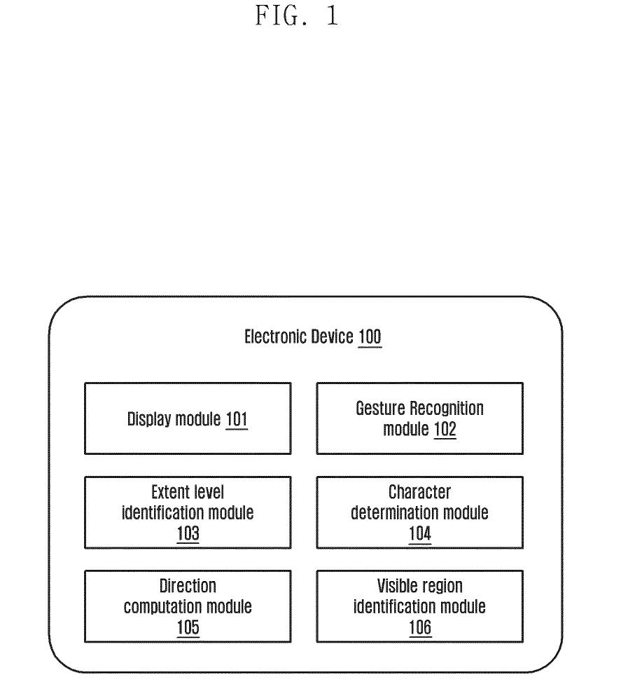

Referring now to the drawings, and more particularly to FIGS. 1 through 14, where similar reference characters denote corresponding features consistently throughout the figures, there are shown preferred various embodiments.

FIG. 1 illustrates an electronic device 100 with various modules, according to various embodiments of the present disclosure.

Referring to FIG. 1, the electronic device 100 includes a display module 101, a gesture recognition module 102, an extent level identification module 103, a character determination module 104, a direction computation module 105, and a visible region identification module 106.

In an embodiment of the present disclosure, the electronic device 100 can be a mobile phone, a Personal Digital Assistant (PDA), a tablet, a wearable device, or the like.

The display module 101 displays the plurality of keys in a matrix in a screen of the electronic device 100. The display module 101 provides user interface functionality in receiving an input from the user on the displayed key. In an embodiment, the input can be a touch input. The display module 101 senses the input by the user on the key and sends the input to other modules in the electronic device 100.

The gesture recognition module 102 module recognizes and identifies the gesture performed on the key displayed on the screen of the electronic device 100. Based on the identified gesture, the corresponding character is displayed on the electronic device. For example, when the user touches the key (numbered 2), the gesture recognition module 102 identifies the touch gesture and the display module 101 displays the number 2 in the display area of the electronic device. In an embodiment, the gesture recognition module 102 identifies a hover gesture performed over the key and sends the character in the key to the display module 101 to display the corresponding key.

The extent level identification module 103 is configured to identify the extent level in which a gesture is performed on a key. For example, when a user touches a key (numbered 2) then 2 is displayed. In this case, the extent level is zero (0). When the user extends the gesture to a pre-defined direction or to any direction from the initial touch gesture (from key numbered 2), then the extent level will increase based on the extent of gesture as identified by the extent level identification module 103.

The character determination module 104 is configured to determine the character associated with the extent level of the gesture performed on the key. For example, when a user initially touches a key (numbered 3) and he extends the gesture (without removing his finger) to a direction, then the extent level identification module 103 identifies the extent level and the character determination module 104 determines the character associated with the identified extent level. In an embodiment, the character determination module 104 identifies the character based on a mapping table available in the memory of the electronic device 100 which includes the details of the direction and the mapped character.

The direction computation module 105 is configured to track the direction in which the user performs the gesture. For example, the user selects the key (numbered 3) and then performs a downward direction on the key. This downward direction is computed by the direction computation module 105 based on the path tracked by the gesture. From the computed direction the character can be determined and displayed in the display area of the electronic device 100.

The visible region identification module 106 is configured to identify the visible region of screen of the electronic device 100 to a user. A gyroscope sensor, bend sensor, or one or array of sensors) can be used to identify the visible region, for example. The matrix is preferably changed based on the visible region of the electronic device 100. For example, the visible region of the wearable device is limited to a certain area. In this case, the appropriate keypad in the visible region is 2*2 matrix keypad and the display module 101 displays the 2*2 matrix keypad. When the visible region identification module 106 identifies the visible region to be large, then the display module 101 dynamically displays the appropriate keypad configuration. This helps the user to select the character based on the visible region of the electronic device 100.

In an example, the screen size of the wearable watch is limited. The visible region identification module 106 identifies the visible region in the wearable watch and displays the 2*2 matrix keypad. The same wearable watch can be used as a typical mobile phone by unlocking the strap of the wearable watch. In this case, the visible region identification module 106 identifies the visible region in the wearable watch and displays 6*2 matrix keypad.

In the disclosed embodiment of the present disclosure, the visible region identification module 106 is configured to identify the orientation of the electronic device 100 and change the keypad matrix dynamically.

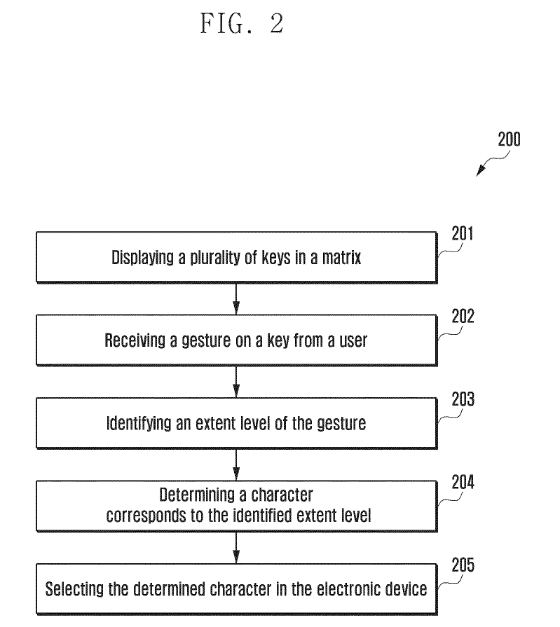

FIG. 2 is a flow diagram illustrating a method 200 of selecting a character in an electronic device, according to various embodiments of the present disclosure. At operation 201, the method 200 includes displaying a plurality of keys in a matrix. Further, the display module 101 is configured to change the keypad configuration by identifying the visible region of the electronic device 100. For example, the display module 101 is configured to display the keypad configuration in a 6*2 keypad matrix by identifying that the visible region of the electronic device 100 is vertical.

At operation 202, the method 200 includes receiving a gesture on a key from a user. The gesture recognition module 102 identifies the gesture. For example, when the user initially touches a key then the character associated with the key is displayed dynamically. In accordance with a disclosed embodiment, the gesture can be a touch gesture, hover gesture, or the like.

At operation 203, the method 200 includes identifying an extent level of the gesture. The extent level identification module 103 to identify the extent level of the gesture. For example, if the user initially touches the key numbered 2, then the character 2 is displayed instantaneously. In this case, the extent level is zero. When the user extends the gesture across any direction or to a pre-defined direction displayed in the key, then the method 200 identifies the extent level. For example, the extent level can be identified by change in pixel values, or key block length.

At operation 204, the method 200 includes determining a character corresponding to the identified extent level. The character determination module 104 determines the character corresponding to the identified extent level. For example, the user performs the gesture on the key numbered 2, then the user extents the gesture in the pre-defined direction. The extent level identification module 103 can be configured to identify the extent level of the gesture. The character determination module 104 determines the character based on the extent level. For example, the key numbered 2 is associated with character 2, A, B, C, based on the identified extent level, the character determination module 104 determines the character A, B or C to be selected by the user.

In a preferred embodiment of the present disclosure, the character determination module 104 instantaneously displays the character before the gesture is completed. This creates an enriched user experience to display the characters associated with the extent level when the user performs the gesture on the key.

At operation 205, the method 200 includes selecting the determined character in the electronic device 100. The display module 101 selects the determined character and displays the determined character in the screen of the electronic device 100.

The method 200 and other description described herein provide a basis for a control program, which can be implemented using a microprocessor, microcontroller, or equivalent thereof. Further, the various actions, units, operations, blocks, or acts described in the method 200 can be performed in the order presented, in a different order, simultaneously, or a combination thereof. Furthermore, in some embodiments, some of the actions, units, operations, blocks, or acts listed in FIG. 2 may be omitted, added, skipped.

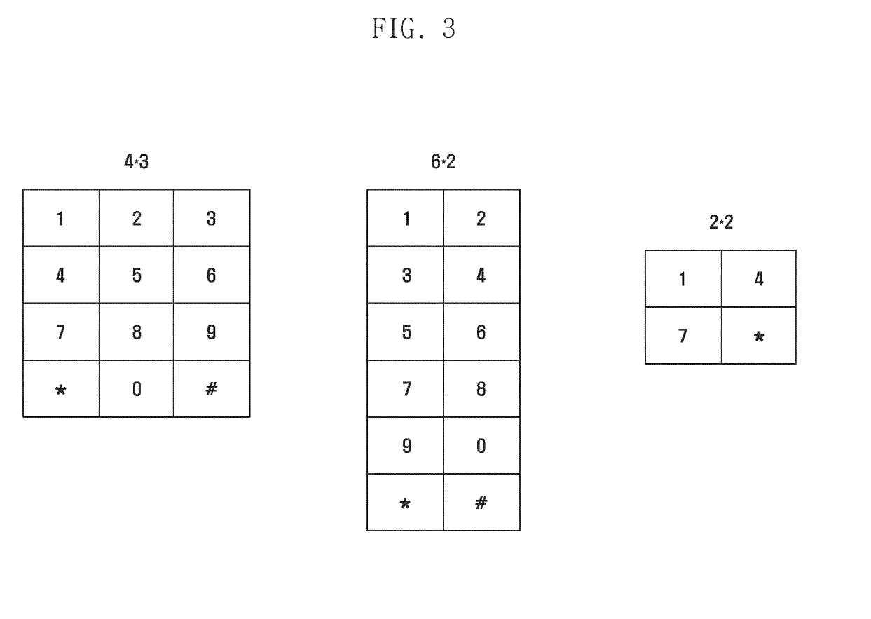

FIG. 3 is an example pictorial representation showing different keypad configurations in an electronic device, according to various embodiments of the present disclosure. In an example, FIG. 3 depicts the keypad configurations in 4*3, 6*2 and 2*2 matrices. The direction corresponding to selecting the character can be displayed in the key each key associated with a plurality of characters. For example, a first key is associated with 1, ., @, /, :, ;, special characters or the like. The direction to select the characters can be displayed in the first key. As an example, in a 4*3 matrix keypad, a user desires to select character ‘F’. The user touches the third key and initially the device displays character 3. To select character ‘F’, the user extends the touch gesture to any direction. Based on a determined extent level, the device instantaneously displays the character before the gesture is completed. For example, when a certain extent level is reached, the character ‘D’ will be displayed. The user, accordingly, extends the gesture to select ‘F’. The display module 101 displays ‘D’, ‘E’ instantaneously.

The 2*2 keypad configurations shown in the FIG. 3 provides a convenient way to input characters in the wearable electronic device. For example, the user can use the thumb finger to input one or more characters in the electronic device 100.

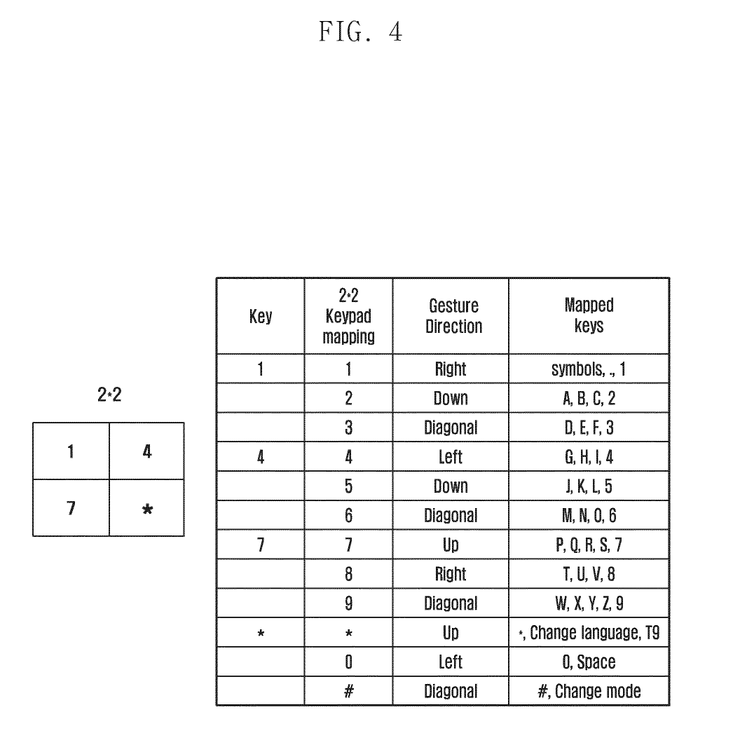

FIG. 4 shows an example 2*2 matrix keypad and key mapping associated with a pre-defined gesture direction, according to various embodiments of the present disclosure.

Referring to FIG. 4, the 2*2 matrix keypad consists of four keys: 1, 4, 7 and *. With these four keys, the user inputs, one or more characters based on the characters associated with these four keys. As depicted in the table, first key 1 is associated with characters 1, 2, and 3. Based on the direction in which the user extends the gesture, the character 1 is associated with symbols, 1, ;, @, :, special characters. The electronic device 100 determines the designated key region and displays the designated character initially. Based on the direction, the characters associated with the displayed character are displayed instantaneously. For example, if the user desires to input O, then the user touches the 2nd key (displayed as 4) and then he extends the gesture diagonally. Initially characters M, N will be displayed based on the extent level associated with the extended gesture. The desired character ‘O’ is displayed when the extent level associated with the gesture performed diagonally corresponds to the character ‘O’.

Apart from the directions mentioned in the table, the user can also perform clockwise direction gesture to select the character. In this case, the extent level associated with the clockwise direction is identified and the associated character is displayed.

In an embodiment, the keypad mappings are cycled in case the gesture is ongoing and the end of the key map is reached, for example, 2, a, b, c, 2, a, b, c, 2, a, b, c.

If the user passes a designated character while performing the gesture, then the user can trace back the path to reach the designated character. For example, the user wants to input an ‘a’, but while performing the gesture the user reached ‘c’, then he can trace back in the same direction to reach character ‘b’ and then ‘a’.

In the case of the 2*2 and 6*2 matrix keypads, after determining the initial direction, gesture cycling can happen in an anti-clockwise direction in any number of times to trace back to reach the designated character.

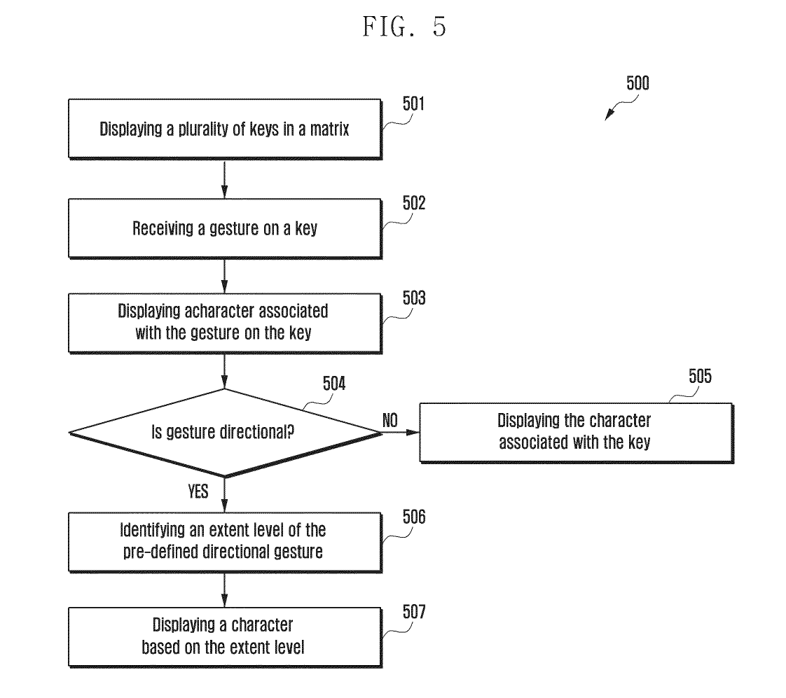

FIG. 5 is an example flow diagram illustrating a method 500 of selecting a character based on an extent level associated with a pre-defined directional gesture, according to various embodiments of the present disclosure. At operation 501, the method 500 includes displaying a plurality of keys in a matrix by the display module 101. At operation 502, the method 500 includes receiving a gesture on a key. The gesture recognition module 102 identifies the gesture and displays an appropriate character in the screen of the electronic device 100.

At operation 503, the method 500 includes displaying the character associated with the designated key. For example, when the user touches the key (numbered 6), then number 6 will be displayed.

At operation 504, the method 500 includes determining whether the received gesture is directional. If it is determined at operation 504 that the gesture is not directional, then at operation 505, the method 500 includes displaying only the character associated with the key. For example, when the user touches the key (numbered 2) the character associated with the key (2) is displayed.

If it is determined at operation 504 that the gesture is directional, then at operation 506 the method 500 includes identifying an extent level of the pre-defined directional gesture. The direction computation module 105 computes the direction in which the gesture is performed. The extent identification module then identifies the extent level of the gesture.

At operation 507, the method 500 includes displaying a character based on the identified extent level. The character determination module 104 determines the character associated with the extent level and displays the determined character in the screen of the electronic device 100.

The method 500 and other description described herein provide a basis for a control program, which can be implemented using a microprocessor, microcontroller, or equivalent thereof. Further, the various actions, units, operations, blocks, or acts described in the method 500 can be performed in the order presented, in a different order, simultaneously, or a combination thereof. Furthermore, in some embodiments, some of the actions, units, operations, blocks, or acts listed in FIG. 5 may be omitted, added, skipped.

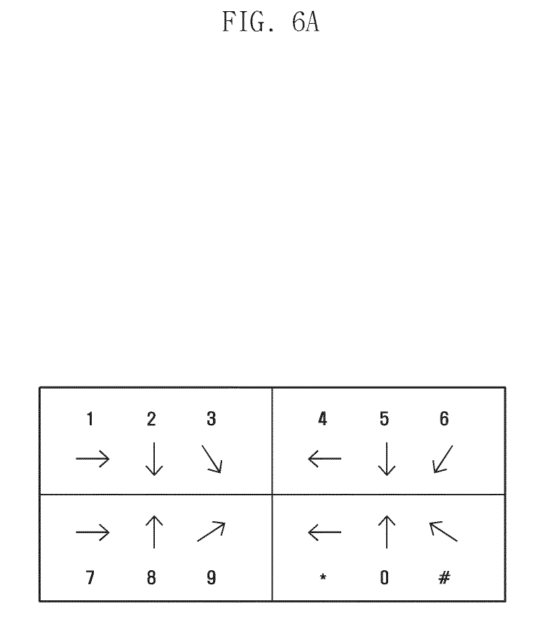

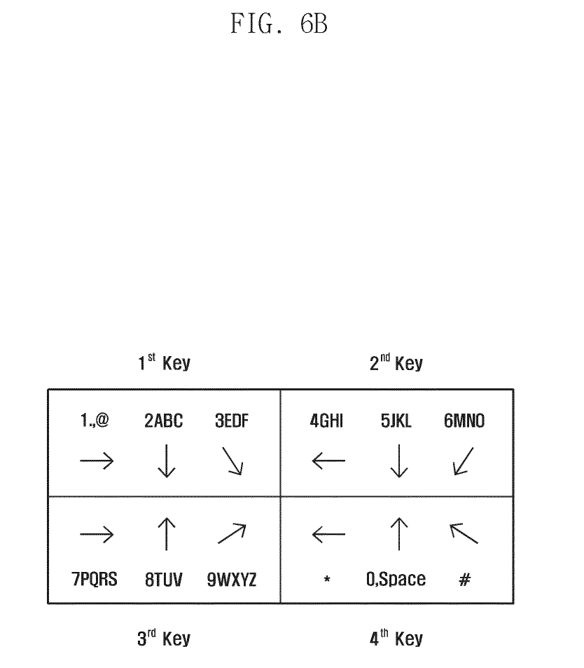

FIGS. 6A and 6B show example keypad layouts in a 2*2 matrix, according to embodiments of the present disclosure. FIG. 6A shows four keys with pre-defined directions. The user can input any character by performing a gesture in the pre-defined direction shown in every number. For example, when the user desires to input character ‘B’, the user first selects number ‘2’, and then extends the gesture towards the downward direction. Initially, the electronic device 100 displays ‘A’, then when the user further extends the gesture, the electronic device 100 is caused to display ‘B’. If user desires to input the character in lower case, then the user has to select ‘#’ and extend the gesture in the diagonal direction.

FIG. 6B shows four keys along with the pre-defined direction and the characters associated with the pre-defined direction. By displaying the 2*2 matrix keypad shown in FIG. 6B, the user selects the character based on the pre-defined direction associated with each key.

In an embodiment, the electronic device 100 selects the next character based on the pixel values.

In an embodiment, the electronic device 100 selects the next character based on the key block length.

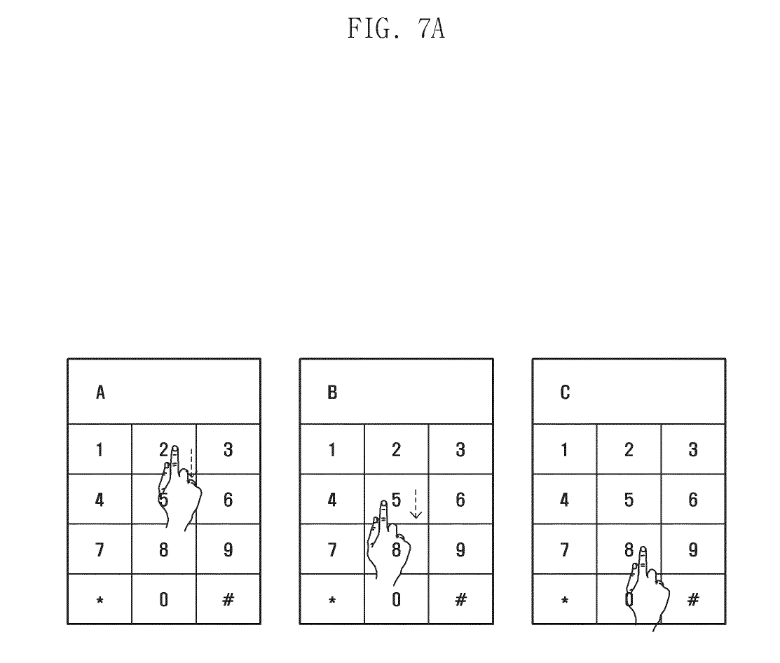

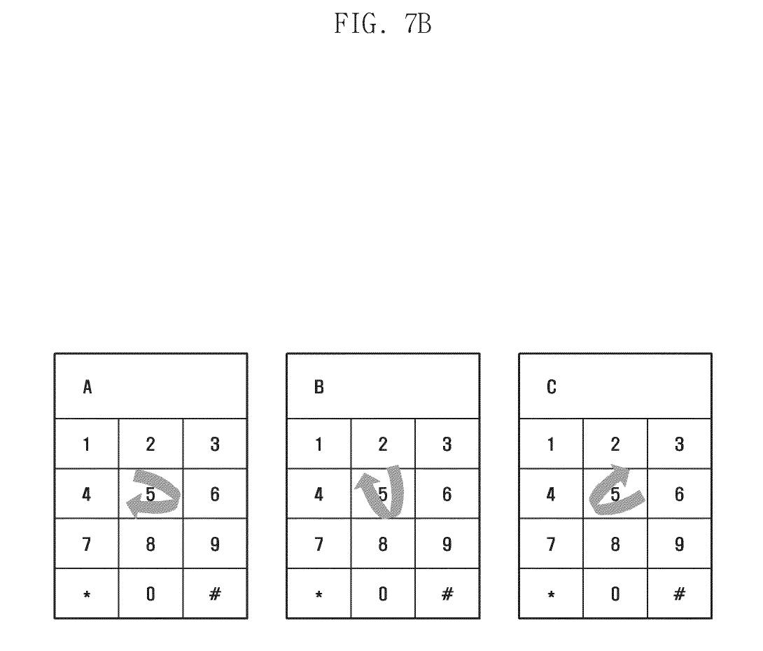

FIGS. 7A and 7B are pictorial representations of selecting a character associated with a key in a 4*3 keypad configuration, according to various embodiments of the present disclosure. FIG. 7A depicts the mechanism to select character ‘b’ in the 4*3 matrix keypad. To select ‘b’, the user touches the number 2 and extends to a level. Initially, character ‘a’ appears in the display area. Based on the extent level of the touch input, the character ‘b’ is displayed in the display area. If the user again extends the touch input the character ‘c’ is displayed as depicted in FIG. 7A.

FIG. 7B shows the selection of the character based on the extent level of the gesture performed in a clock-wise direction. In case the user has past the designated key, the user can track back the path by performing the anti-clockwise direction to return to the desired key.

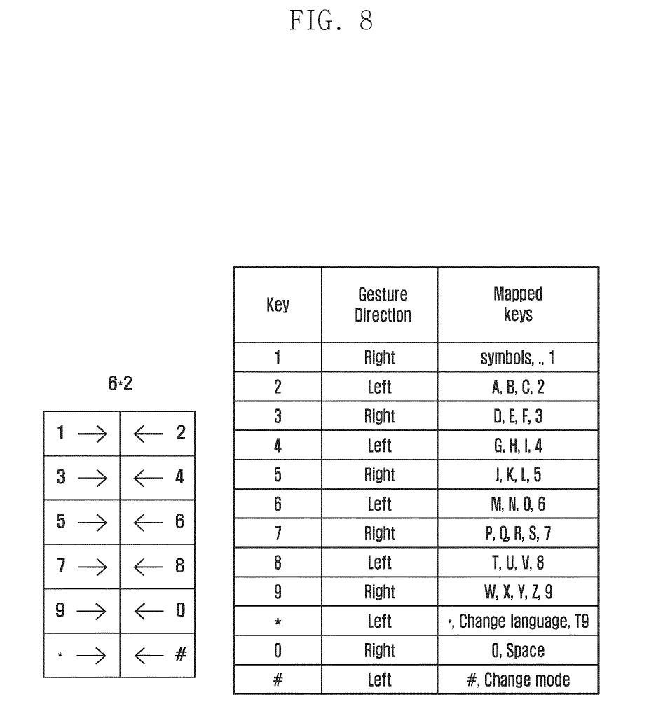

FIG. 8 shows an example 6*2 matrix keypad and key mapping associated with a pre-defined gesture direction, according to various embodiments of the present disclosure. The pre-defined direction in the 6*2 matrix keypad and key mapping associated with the gesture direction on the key is shown. As shown in FIG. 8, the 6*2 matrix keypad includes the pre-defined direction in all keys which helps the user input the characters associated with the keys based on the direction in which the user extends the gesture. For example, if the user desires to input character ‘M’ by performing the touch gesture on the key number ‘6’. Initially, the electronic device 100 displays ‘6’ and when the user further performs the touch gesture in the left direction (as shown) in the key, then the electronic device 100 displays ‘M’. This enhances the user experience in selecting the character using the touch gesture.

In an embodiment, when the user wishes to change the input mode to lower case, the user performs the touch gesture on character ‘#’, then extends the gesture towards the left direction.

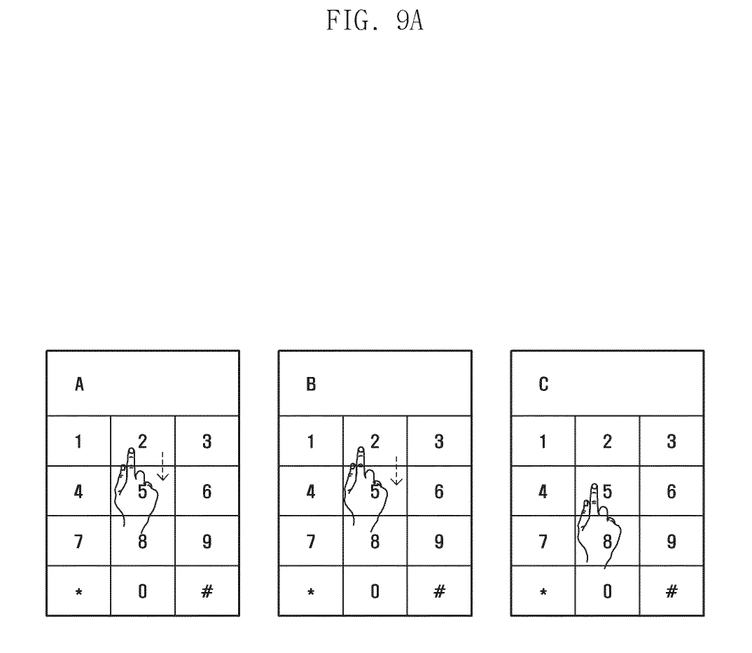

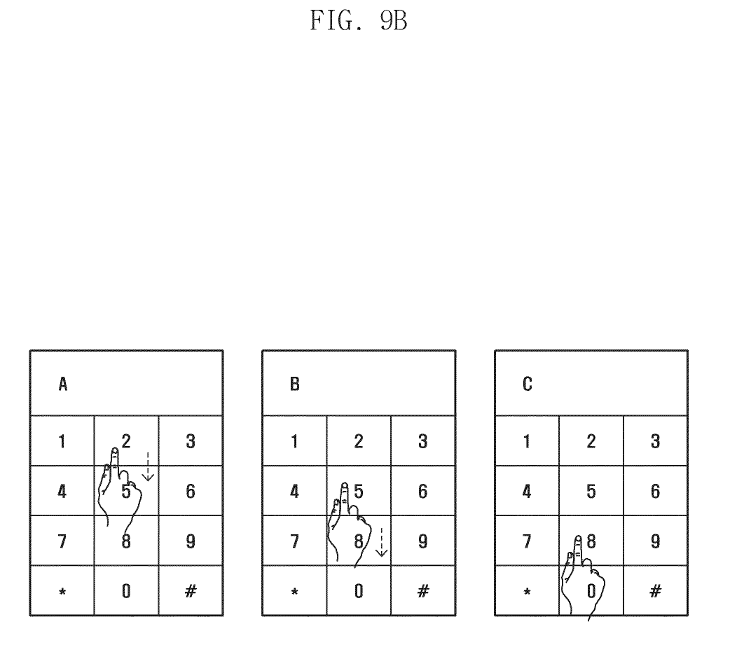

FIGS. 9A and 9B show example illustrations of selecting a character, according to various embodiments of the present disclosure. The FIG. 9A shows the selection of character based on the change in pixel values. For example, when the user desires to input ‘C’ and performs a touch gesture on key number 2. Initially the electronic device 100 displays the character ‘2’ in the display area. When user extends the gesture in the downward direction, then based on the change in pixel values the electronic device 100 displays the next character ‘A’ in the display area. The electronic device 100 determines that the user gesture crossed a certain number of pixels (for example: 20 pixels) and changes the character to ‘B’ and so on.

The FIG. 9B shows the selection of a character based on the key length. For example, when a user desires to input character ‘C’ and the user performs a gesture on the key numbered 2. Initially, the electronic device 100 displays character 2 in the display area. When the user extends the gesture in the downward direction, the electronic device 100 determines that the gesture moves a full key length (for example: 2 key, 5 key) and changes the display to the character ‘A’ and so on. Thus, based on the key length, the next character is selected and displayed in the display area.

FIG. 10 is a flow diagram illustrating a method 1000 of removing one or more displayed characters based on a gesture, according to various embodiments of the present disclosure. At operation 1001, the method 1000 includes displaying one or more characters corresponding to an extent level. The display module 101 displays the one or more characters based on the extent level of the gesture in the keypad. At operation 1002, the method 1000 includes receiving the gesture. The gesture recognition module 102 identifies the gesture performed by the user on the displayed matrix keypad.

At operation 1003, the method 1000 includes determining whether the gesture is directional. The direction computation module 105 to compute the direction of the gesture performed by the user on the displayed keypad. If it is determined at operation 1003, that the gesture is directional, then at operation 1004, the method 1000 includes identifying the number of fingers used to perform the gesture. The direction computation module 105 computes the direction. In accordance with an embodiment, the multi-touch recognition module embedded in the screen of the electronic device 100 to identify the number of fingers used to perform the gesture.

At operation 1005, the method 1000 includes removing one or more characters based on the number of fingers used for performing the gesture. The display module 101 removes the displayed one or more characters based on the number of fingers used in the performing the gesture. For example, it if is determined that only one finger is used in the gesture, and then the method 1000 removes only one character in the displayed characters.

Alternatively, the method 1000 removes all the displayed characters in the display area after identifying that the user performs the gesture using only one finger.

Based on the pre-defined configuration the method 1000 removes the character (s) based on the gesture performed using one or more fingers.

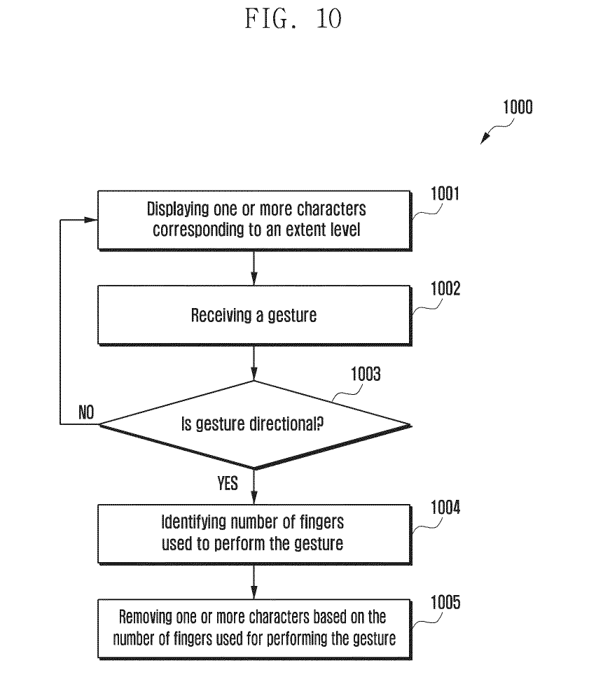

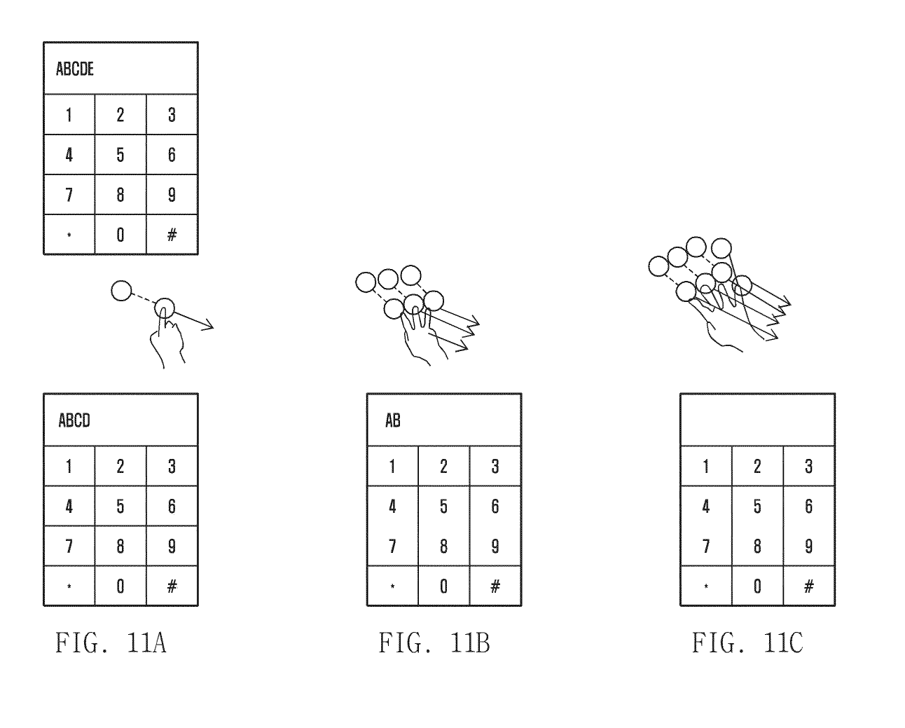

FIGS. 11A, 11B, and 11C show example pictorial representations of removing one or more characters as described in FIG. 10, according to various embodiments of the present disclosure. Initially, the displayed characters in the display area are ABCDE. In an example, as shown in FIG. 11A, the user intends to remove the last character ‘E’. The user performs a gesture to remove the character ‘E’, for example, the user performs a flick (or swipe) to remove the character ‘E’. The user performs this gesture from the same extent level which is determined to display character ‘E’. To display an ‘E’ the user touches on character 3 and extends the gesture to the pre-defined direction, for example. Based on the extent level the character ‘E’ is displayed. Intending to remove character ‘E’, the user performs the gesture from the same extent level for which the character ‘E’ is displayed.

Alternatively, the user performs the gesture to remove all the displayed characters.

The FIG. 11B shows the representation of removing more than one character using more than one finger. As shown, the user intends to remove characters ‘CDE’ displayed in the display area. To remove characters ‘CDE’, the user performs the gesture using 3 fingers. For example, the user performs a flick gesture using three fingers to remove three characters.

In an alternative embodiment, the user performs the gesture using three fingers to remove all the displayed characters.

The FIG. 11C shows the representation of removing all the displayed characters in the display area. The user intends to remove ‘ABCDE’ from the display area. For example, the user performs the flick gesture using four fingers to remove all of the displayed characters.

In an embodiment, the user performs the gesture diagonally to remove one or more displayed characters.

The proposed method pre-configures the removal of characters based on the number of fingers used in the gesture.

In an alternate embodiment, when the user intends to remove a word, the user can perform a gesture using one finger to remove one word.

In an embodiment, the method allows to configure the display area to remove one or more characters based on the number of fingers used to perform the gesture (for example: flick gesture).

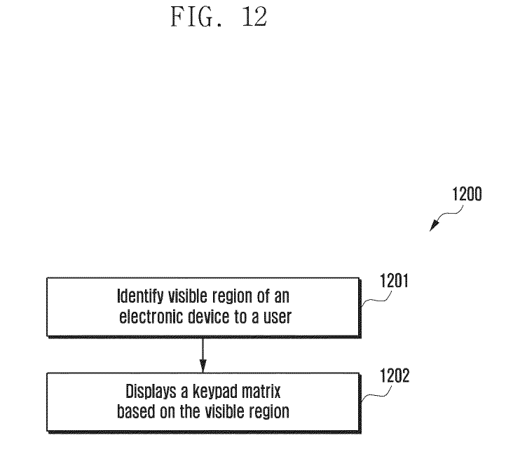

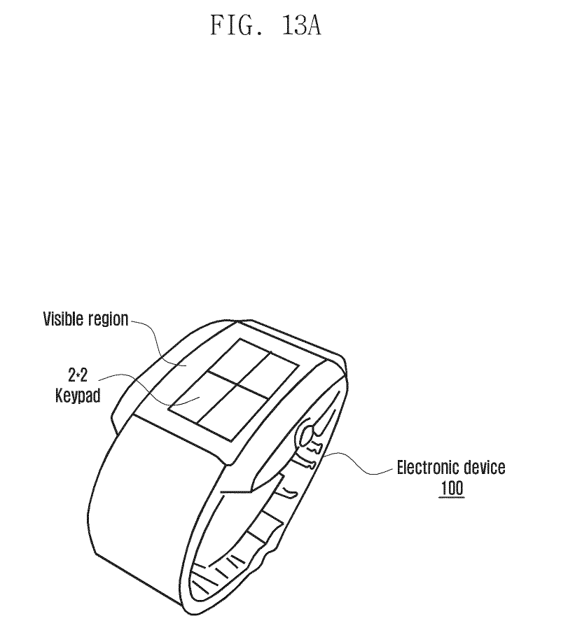

FIG. 12 is a flow diagram illustrating a method 1200 of displaying a matrix with a plurality of keys based on a visible region of an electronic device, according to various embodiments of the present disclosure. At operation 1201, the method 1200 includes identifying the display portion/visible region of an electronic device 100. The visible region identification module 106 identifies the visible region of the electronic device 100. For example, a gyroscope sensor, a bend sensor, or one or an array of sensors is used to detect the visible region in electronic device 100, and display the keypad configuration accordingly. In an embodiment, the method 1200 identifies the display region of the electronic device 100, and displays the keypad configuration accordingly.

At step 1202, the method 1200 includes displaying a keypad configuration based on the visible region. In an embodiment, the method 1200 allows the display module 101 to display the matrix keypad configuration based on the identified display/visible region at operation 1202.

For example, when the user uses a wearable watch, the keypad configuration suitable for the watch will be 2*2 matrix keypad. This provides enhanced user experience to input character based on the visible region of the electronic device.

The method 1200 and other description described herein provide a basis for a control program, which can be implemented using a microprocessor, microcontroller, or equivalent thereof. Further, the various actions, units, operations, blocks, or acts described in the method 1200 can be performed in the order presented, in a different order, simultaneously, or a combination thereof. Furthermore, in some embodiments, some of the actions, units, operations, blocks, or acts listed in FIG. 12 may be omitted, added, skipped.

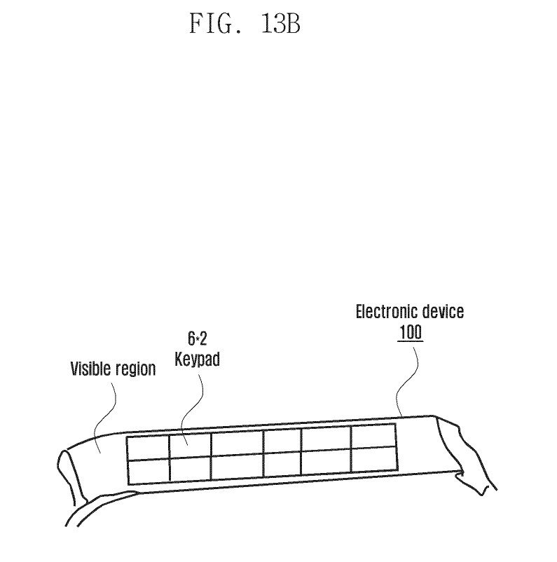

FIGS. 13A and 13B show example pictorial representations of displaying a matrix with a plurality of keys based on a visible region of an electronic device as described in FIG. 12, according to various embodiments of the present disclosure. For example, the electronic device 100 shown in the FIG. 13A is a wearable watch. The disclosed method identifies the visible region in the wearable watch and displays the keypad configuration accordingly. When the same wearable watch is unfolded, then the screen of the wearable watch will be enlarged as shown in FIG. 13B. The proposed method identifies the visible region in the wearable watch and displays the appropriate keypad configuration. For example, a 6*2 matrix keypad is displayed in the visible region of the wearable watch as shown in FIG. 13B.

In an embodiment, the method dynamically changes the keypad configurations based on the visible region of the electronic device.

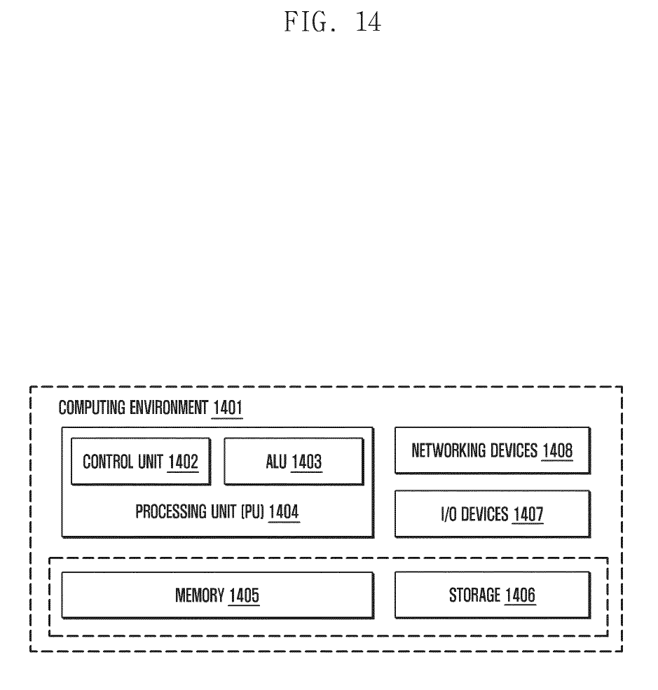

FIG. 14 illustrates a computing environment implementing a method and system for selecting a character in an electronic device, according to various embodiments of the present disclosure.

Referring to FIG. 14, the computing environment 1401 includes at least one processing unit 1404 that is equipped with a control unit 1402 and an Arithmetic Logic Unit (ALU) 1403, a memory 1405, a storage unit 1406, plurality of networking devices 1408 and a plurality of Input/Output (I/O) devices 1407. The processing unit 1404 is responsible for processing the instructions of the algorithm. The processing unit 1404 receives commands from the control unit 1402 in order to perform its processing. Further, any logical and arithmetic operations involved in the execution of the instructions are computed with the help of the ALU 1403.

The algorithm composed of instructions and codes required for the implementation are stored in either the memory unit 1405 or the storage 1406 or both. At the time of execution, the instructions may be fetched from the corresponding memory 1405 and/or storage 1406, and executed by the processing unit 1404.

In case of any hardware implementations various networking devices 1408 or external I/O devices 1407 may be connected to the computing environment to support the implementation through the networking unit 1408 and the I/O device unit 1407. The various embodiments disclosed herein can be implemented through at least one software program running on at least one hardware device and performing network management functions to control the network elements.

The various embodiments disclosed herein can be implemented through at least one software program running on at least one hardware device and performing network management functions to control the elements. The elements shown in FIGS. 13A, 13B, and 14 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for determining at least one character in an electronic device, the method comprising:
displaying a plurality of keys, wherein each key is associated with a plurality of characters;
identifying at least one extent level of at least one gesture performed by the user on the at least one key, wherein each extent level corresponds to the at least one character associated with the key; and
determining the at least one character corresponding to the at least one identified extent level.

2. The method of claim 1, further comprising:
selecting the at least one determined character in the electronic device.

3. The method of claim 2, wherein the at least one character is selected when the at least one gesture is performed in a pre-defined direction associated with the at least one key.

4. The method of claim 1, further comprising:
displaying instantaneously at least one character associated with the key before the at least one gesture is completed.

5. The method of claim 2, wherein the selecting of the at least one determined character comprises displaying the at least one determined character in the electronic device.

6. The method of claim 5, further comprising:
removing the at least one displayed character in response to receiving at least one gesture.

7. The method of claim 1, wherein the plurality of keys is displayed based on a visible region of the electronic device.

8. An electronic device comprising:
an integrated circuit comprising at least one processor;
at least one memory having a computer program code within the circuit;
the at least one memory and the computer program code with the at least one processor cause the electronic device to:
display a plurality of keys, wherein each key is associated with a plurality of characters;
identify at least one extent level of at least one gesture performed by a user on the at least one key, wherein each extent level corresponds to at least one the plurality of characters associated with the key using an extent level identification module; and
determine at least one the plurality of characters corresponds to the at least one identified extent level using a character determination module.

9. The electronic device of claim 8, wherein the electronic device is further configured to select the at least one determined character.

10. The electronic device of claim 8, wherein the at least one character is selected when the at least one gesture is performed in a pre-defined direction associated with the at least one key.

11. The electronic device of claim 8, wherein the electronic device is further configured to instantaneously display at least one character associated with the key before the at least one gesture is completed.

12. The electronic device of claim 8, wherein the electronic device is further configured to display the at least one determined character in the electronic device after the at least one determined character is selected.

13. The electronic device of claim 11, wherein the electronic device is further configured to remove the at least one displayed character in response to receiving at least one gesture using a character removal module.

14. The electronic device of claim 8, wherein the plurality of keys is displayed based on a visible region identified using a visible region identification module.

15. A non-transitory computer program product comprising computer executable program code recorded on a computer readable non-transitory storage medium, the computer executable program code when executed causing the actions including:
displaying a plurality of keys in an electronic device, wherein each key is associated with a plurality of characters;
identifying at least one extent level of at least one gesture performed by a user on the at least one key, wherein each at least one extent level corresponds to at least one the plurality of characters associated with the key; and
determining at least one character corresponds to the at least one identified extent level.

16. The non-transitory computer program product of claim 15, wherein the computer executable program code when executed causing further actions including selecting the at least one determined character in the electronic device.

17. The non-transitory computer program product of claim 16, wherein the at least one character is selected when the at least one gesture is performed in a pre-defined direction associated with the at least one key.

18. The non-transitory computer program product of claim 15, wherein the computer executable program code when executed causing further actions including displaying instantaneously at least one character associated with the at least one key before the at least one gesture is completed.

19. The non-transitory computer program product of claim 15, wherein the selecting of the at least one determined character comprises displaying the at least one determined character on the electronic device.

20. The non-transitory computer program product of claim 18, wherein the computer executable program code when executed causing further actions including removing the at least one displayed character in response to receiving at least one gesture.

21. The non-transitory computer program product of claim 15, wherein the plurality of keys is displayed based on a visible region of the electronic device.
